(19) United States
(12) Patent Application Publication
(10) Pub. No.: US 2025/0340731 A1
(43) Pub. Date: Nov. 6, 2025

(54) COMPOSITION OF MATTER FOR ACCELERATING REACTION OF THERMOSETTING MONOMERS, OLIGOMERS AND/OR RESINS

(71) Applicant: Henkel AG & Co. KGaA, Duesseldorf (DE)

(72) Inventors: Jordan R. Kinney, Cheshire, CT (US); Tanmoy Dey, Unionville, CT (US); Archith Nirmalchandar, Rocky Hill, CT (US); Christian D. Steinmetz, Middletown, CT (US); Fengshuo Hu, Farmington, CT (US)

(21) Appl. No.: 19/260,678

(22) Filed: Jul. 7, 2025

Related U.S. Application Data
(63) Continuation of application No. PCT/US2024/010398, filed on Jan. 5, 2024.
(60) Provisional application No. 63/437,202, filed on Jan. 5, 2023.

(51) Int. Cl. C08L 63/00; C08G 59/18; C08G 59/24; C08G 59/50; C08K 3/22; C08K 3/36

(52) U.S. Cl. CPC C08L 63/00; C08G 59/184; C08G 59/24; C08G 59/5013; C08G 59/502; C08K 3/22; C08K 3/36; C08K 2003/2241; C08L 2205/035; C08L 2207/53

(57) ABSTRACT

A composition of matter for accelerating reaction of thermosetting monomers, oligomers and/or resins, and two-part compositions one part of which comprised the inventive composition of matter is provided.

### BACKGROUND

### Field

A composition of matter for accelerating reaction of thermosetting monomers, oligomers and/or resins, and two-part compositions one part of which comprised the inventive composition of matter is provided.

### Brief Description of Related Technology

Two-part epoxy-based structural adhesives are known.

For instance, U.S. Pat. No. 8,491,749 describes and claims a two-part structural adhesive composition comprising a curable epoxy resin, an amine curing agent, a toughening agent, and a reactive liquid modifier. More specifically, in this context, the '749 patent requires the reactive liquid modifier to be
(i) an acrylate functionalized compound selected from the group consisting of:
(a) an acrylate functionalized compound having the general formula

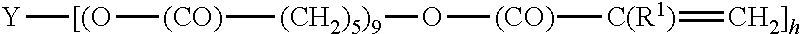

wherein Y is a branched or linear alkyl chain having from about 1 to 10 carbon atoms or a heteroalkyl chain having from about 1 to 10 carbon atoms; each R₁, independently, H or a C₁-C₄ alkyl; each g is, independently, an integer value ranging from about 1 to 35; and h is an integer value ranging from about 1 to 22; and
(b) an acrylate functionalized compound having the general formula

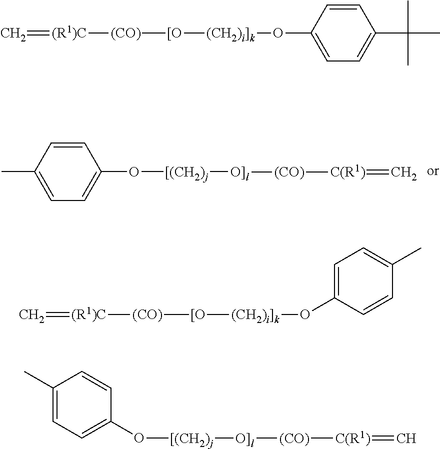

wherein
each R¹ is, independently, H or a C₁-C₄ alkyl;
i and j are each, independently, integer values ranging from about 1 to 10; and
k and I are each, independently, integer values of at least 1 whose combined sum ranges from about 2 to 135,
(ii) an acrylamide functionalized compound.
(iii) an oxalic amide functionalized compound,
(iv) an acetoacetoxy functionalized urethane,
(v) an acetoacetoxy functionalized polyalkene, or
(vi) combination thereof.

In addition, U.S. Pat. No. 10,280,345 is directed to and claims a two-part structural adhesive. Here, the '345 patent defines the adhesive as one comprising: A) a curative part comprising: i) one or more epoxy curatives, where the one or more epoxy curatives include norbornane diamine (NBDA); and il) a reaction intermediate which is the reaction product of a liquid epoxy resin having an epoxy functionality of 2 with an excess of the epoxy curatives; and B) an epoxy part comprising: iii) one or more multifunctional epoxy resins having an epoxy functionality of greater than 2.2. In some embodiments the one or more epoxy curatives additionally include 4,7,10 trioxa-1,13-Iridecane-diamine (TDD).

Notwithstanding the state of the art, it would be desirable to provide alternative solutions from which the manufacturing public may choose for the particular application at hand.

### SUMMARY

Accordingly, provided herein in its broadest form is a composition of matter for accelerating reaction of thermosetting monomers, oligomers and/or resins. This composition of matter comprises reaction products of (i) one or more hydrogenated bisphenol A or F epoxy resins, or cycloaliphatic epoxy resins, and (ii) diamine-functionalized straight chain alkylene oxides.

In addition to the reaction products, the composition of matter may optionally include diamine-functionalized straight chain alkylene oxide, either the same or different diamine-functionalized straight chain alkylene oxides, or combinations thereof.

The diamine-functionalized straight chain alkylene oxides may be polyether diamines, such as those derived from polyethylene oxide or polypropylene oxide.

In another aspect, provided herein is a two-part curable composition. The two-part curable composition comprises:
Part A composition comprising a thermosetting monomer, oligomer and/or resin component; a toughener component; and a filler component; and
Part B composition comprising reaction products of (i) one or more hydrogenated bisphenol A or F epoxy resins, or cycloaliphatic epoxy resins, and (ii) diamine-functionalized straight chain alkylene oxides.

As noted, the Part A composition of the two-part curable composition comprises a toughener component, which may be a core shell impact modifier.

Reaction products of the two-part curable composition demonstrate a plethora of desirable physical properties. For instance, such reaction products have two or more of the following physical properties: adhesion strength of between about 20 MPa to about 50 MPa when disposed and cured onto one or more of aluminum, titanium, or steel, color stability as measured by UV resistance DE between 0 and 10 after 300 hours, izod impact strength of between about 50 J/m and about 150 J/m, chemical resistance to about 95° C. temperature acid baths of about pH of about 0.1 to about 2 for a period of time of up to about 1 hour while retaining at least about 70% of initial adhesion, Tg of between about 50° C. and about 150° C., modulus between about 1 GPa and about 3 GPa and elongation between about greater than 0% and about 100%.

### DETAILED DESCRIPTION

As noted above, provided herein in its broadest form is a composition of matter for accelerating reaction of thermosetting monomers, oligomers and/or resins. This composition of matter comprises reaction product of (i) one or more hydrogenated bisphenol A or F epoxy resins, or cycloaliphatic epoxy resins, and (ii) diamine-functionalized straight chain alkylene oxides.

As noted above, in addition to the reaction products, the composition of matter may optionally include diamine-functionalized straight chain alkylene oxide, either the same or different diamine-functionalized straight chain alkylene oxides, or combinations thereof.

In the composition of matter, the one or more hydrogenated bisphenol A or F epoxy resins, or cycloaliphatic epoxy resins, may have a number average molecular weight of between about 200 and about 700, such as about 350.

In the composition of matter, the one or more hydrogenated bisphenol A or F epoxy resins, or cycloaliphatic epoxy resins, should be present in an amount of about greater than 0 percent by weight to about 70 percent by weight of the composition of matter, such as about 50 percent by weight, desirably about 45 percent by weight.

In the composition of matter, the one or more hydrogenated bisphenol A or F epoxy resins, or cycloaliphatic epoxy resins, is desirably hydrogenated bisphenol A epoxy resin. Commercially available examples of the hydrogenated bisphenol A epoxy resin include jER YX 8000D and jER YL 983U, each from Mitsubishi Chemical, Japan.

In the composition of matter, the diamine-functionalized straight chain alkylene oxides may be polyether diamines, such as those derived from polyethylene oxide or polypropylene oxide.

In the composition of matter, the diamine-functionalized straight chain alkylene oxides may have a number average molecular weight in the range of about 150 to about 300, such as about 220.

In the composition of matter, the diamine-functionalized straight chain alkylene oxides may be present in an amount of about 30 to about 99 percent by weight of the reaction product, such as about 55 percent by weight.

In the composition of matter, the diamine-functionalized straight chain alkylene oxides may be selected from polyether diamines, such as 4,7,10-trioxatridecane-1,13-diamine, 4,9-dioxadodecane-1,12-diamine, polyetheramine D-230, polyetheramine D-400, polyetheramine T-403, or 3,6-dioxaoctamethylenediamine. Commercially available examples of these include respectively ANCAMINE 1922A, ANCAMINE 1618, and ANCAMINE 2638; Baxxodur EC-130, Baxxodur EC-280, Baxxodur EC301, Baxxodur EC-302, and Baxxodur EC 310; and Jeffamine EDR-148, from Evonik, Bayer, and Huntsman, respectively. BASF also supplies diamine-functionalized straight chain alkylene oxides useful herein.

Among other things, the inventive composition of matter may be used in one part of a two-part curable composition. For instance, the two-part curable composition may comprise a Part A composition and a Part B composition. Ordinarily, but not necessarily, the Part A composition in practice may be housed in one chamber of a dual chamber cartridge suitable for dispensing. In such case, the Part B composition would then be housed in the other chamber. The two chambers are customarily joined at an outlet or exit orifice where the Part A composition and the Part B composition come into contact as they mix prior to dispensing onto a substrate surface. The mixing time may be extended either by expressing the contents of one or both chamber(s) more slowly or by fitting the outlet or exit orifice with a mixing nozzle. The mixing nozzle not only extends the mixing time by extending the pathway before the mixed composition is expressed from the cartridge, but routinely within the mixing nozzle are baffled configured to increase the mixing efficiency. Sulzer MixPac provides a plethora of mixing nozzle designs.

More specifically, the Part A composition may comprise a thermosetting monomer, oligomer and/or resin component; a toughener component; and a filler component.

Here, desirably the Part A composition comprises an epoxy resin as the thermosetting monomer, oligomer and/or resin component. The epoxy resin should have a number average molecular weight of about 300 to about 700, with about 350 being desirable.

The epoxy resin may be bisphenol A or F epoxy resin, hydrogenated bisphenol A or F epoxy resin, or cycloaliphatic epoxy resins, or combinations thereof. Desirably, the epoxy resin should be bisphenol A epoxy resin or hydrogenated bisphenol A epoxy resin.

The thermosetting monomer, oligomer and/or resin component should be present in the Part A composition in amount of about 20 to about 85 percent by weight, such as about 75, desirably about 74.5, based on the total Part A composition.

The toughener component of the Part A composition may be a core shell impact modifier.

Where the toughener component comprises a core shell impact modifier, the core shell impact modifier may comprise a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer.

Where the toughener component comprises a core shell impact modifier, the core shell impact modifier may comprise a particle having a particle size between about 170 nm and about 350 nm and a pH between about 6 and about 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than about 25° C., each layer having a different polymer composition.

Where the toughener component comprises a core shell impact modifier, the core shell impact modifier may comprise a polymeric rubber core surrounded by a polymeric layer which is a polymeric core layer, the polymeric core layer having a glass transition temperature under 0° C. and a different polymer composition than the polymeric rubber core, wherein said polymeric core layer is present in a gradient zone.

Where the toughener component comprises a core shell impact modifier, the core shell impact modifier may comprise at least one polymeric core layer and at least two polymeric shell layers, the polymeric core layer having a different composition than the polymeric core and the shell layers, wherein each shell layer has a different polymer composition from the other shell layer, and wherein at least one polymeric shell layer is present in a gradient zone.

Where the toughener component comprises a core shell impact modifier. the core shell impact modifier may comprise a polymeric rubber core with a glass transition temperature of less than about −40° C.

Where the toughener component comprises a core shell impact modifier, the core shell impact modifier may comprise a polymeric rubber core with a glass transition temperature of between about −80° C. and about −40° C.

Where the toughener component comprises a core shell impact modifier, the core shell impact modifier may comprise a polymeric rubber core constructed from polybutadiene.

Where the toughener component comprises a core shell impact modifier. the core shell impact modifier may comprise a polymeric rubber core constructed from butadiene and styrene.

Where the toughener component comprises a core shell impact modifier, the core shell impact modifier may comprise a polymeric rubber core constructed from methyl methacrylate, butadiene and styrene.

The core-shell impact modifier should be in the form of fine particles having a rubber core and at least one thermoplastic shell, the particle size being generally less than 1 um and advantageously between 50 nm and 500 nm, preferably between 100 nm and 400 nm, and most preferably 150 nm and 350 nm, advantageously between 170 nm and 350 nm.

The core-shell impact modifier may be prepared by emulsion polymerization. For example, a suitable method is a two-stage polymerization technique in which the core and shell are produced in two sequential emulsion polymerization stages. If there are more shells another emulsion polymerization stage follows. A graft copolymer is obtained by graft-polymerizing a monomer or monomer mixture containing at least an aromatic vinyl, alkyl methacrylate or alkyl acrylate in the presence of a latex containing a butadiene-based rubber polymer. Commercially available examples of such core-shell impact modifiers ae available commercially under the CLEARSTRENGTH tradename from Arkema Inc., Cary, NC. Arkema describes CLEARSTRENGTH XT100, for instance, as a methyl methacrylate-butadiene-styrene core-shell toughening agent, which is compatible with various monomers and easily dispersible in most liquid resin systems and exhibits a limited impact on their viscosity while providing a toughening effect over a wide range of service temperatures.

The toughener component should be present in the Part A composition in an amount of from about 2 percent by weight to about 20 percent by weight, such as about 10 percent by weight, based on the total Part A composition.

The filler component of the Part A composition may comprise titanium dioxide, aluminum nitride, boron nitride, silicon carbide, diamond, graphite, beryllium oxide, magnesia, silicas, such as fumed silica or fused silica, alumina, perfluorinated hydrocarbon polymers (i.e., TEFLON), thermoplastic polymers, thermoplastic elastomers, mica, glass powder and the like. Desirably, the particle size of these fillers will be about 20 microns or less.

As regards silicas, the silica may have a mean particle diameter on the nanoparticle size; that is, having a mean particle diameter on the order of 109 meters. The silica nanoparticles can be pre-dispersed in epoxy resins and may be selected from those available under the tradename NANOCRYL, from Nanoresins, Germany. NANOCRYL is a tradename for a product family of silica nanoparticle reinforced (meth)acrylates. The silica phase consists of surface-modified, synthetic SiO₂ nanospheres with less than 50 nm diameter and an extremely narrow particle size distribution. The SiO₂ nanospheres are agglomerate-free dispersions in the (meth)acrylate matrix resulting in a low viscosity for resins containing up to 50 weight percent silica.

The filler component should be present in an amount of about 1 to about 20 percent by weight, such as about 2 percent by weight, based on the total Part A composition.

The Part B composition may comprise the inventive composition of matter, which is described above.

Optional components may also be included in either one or both the Part A composition or the Part B composition. Such optional components include reactive diluents, defoamers, antioxidants, UV absorbers, hindered amine light stabilizers (“HALS”), wetting agents, and/or colorants, such as dyes or pigments.

Regarding reactive diluents, when included in the inventive two-part curable compositions reactive diluents serve to control the flow characteristics of the adhesive composition. Suitable diluents can have at least one reactive terminal end portion and, preferably, a saturated or unsaturated cyclic backbone. Reactive terminal end portions include glycidyl ether. Examples of suitable diluents include the diglycidyl ether of resorcinol, diglycidyl ether of cyclohexane dimethanol, diglycidyl ether of neopentyl glycol, and triglycidyl ether of trimethylolpropane. Commercially available reactive diluents are, for example, Reactive Diluent 107 (available from Hexion Specialty Chemical, Houston, TX) and EPODIL 757 (available from Air Products and Chemical Inc., Allentown, PA).

When used, the reactive diluent may be used in an amount of about 0.001 to about 25 percent by weight in either or both of the Part A composition and the Part B composition.

When the Part A composition and the Part B composition are mixed together reaction products are formed. The reaction products are suitable to join together two or more substrate surfaces in an adhesive manner.

The substrate surfaces that may be adhesively joined include metals such as aluminum, titanium, steel, and stainless steel.

The reaction products that form should have two or more of the following physical properties: adhesion strength of between about 20 MPa to about 50 MPa when disposed and cured onto one or more of aluminum, titanium, steel, or stainless steel substrates, such as using the protocol described in ASTM D1002-05, color stability as measured by UV resistance DE between 0 and 10 after a period of time of about 300 hours (such as when a combination of the protocol described in ASTM D2565 regarding the xenon lamp exposure and the protocol described in ASTM F1515-21 for the color change), izod impact strength of between about 50 J/m and about 150 J/m, such as when using the protocol described in ASTM D256-23e1, chemical resistance when exposed to 95° C. temperature acid bath with a pH between about 0.1 and 2 for a period of time of up to about 1 hour while retaining at least about 70% of initial adhesion, such as when using the protocol described in ASTM D1002-05, Tg of between about 50° C. and about 150° C., such as when using the protocol described in ASTM E1640-04, modulus between about 1 GPa and about 3 GPa and elongation between about greater than about 0% and about 100%, such as when using the protocol described in ASTM D882-09.

The examples that follow provide further descriptive information from which persons of ordinary skill in the art should be able to practice the invention.

### EXAMPLES

### Formulation 1

In the Part A, the following components in the noted amounts were mixed together:
Resin: 74.5 grams of jER YX 8000D
Toughener: 10 grams of CLEARSTRENGTH XT 100
Filler: 10 grams of titanium dioxide, Ti-Pure R-960
Filler: 2 grams of AEROSIL A200

In the Part B composition, the following components in the noted amounts

were mixed together to form the hardener: Reaction product of 55.5 grams of ANCAMINE 1922A and 44.5 grams of jER YX 8000D; and 20 grams VESTAMIN PACM.

When the Part A composition and the Part B composition were mixed together and dispensed onto one or more of the noted substrates to be mated, the following data was observed and recorded:
Adhesion Strength:
   Aluminum: 30.4 MPa
   Titanium: 33.15 MPa
   Steel: 30.83 MPa
Color Stability: DE94 after 300 hours=1.64
Post chemical bath adhesion:
   Aluminum before chemical bath: 28.6 mPa
   Aluminum after chemical bath: 20.8 mPa
Tg: 66° C.
Young's Modulus: 2.2 GPa
Elongation: 11.89%
Izod: 100 J/m

### Formulation 2

In the Part A composition, the following components in the noted amounts were mixed together:
Resin: 25.5 grams of jER YX 8000D
Resin: 50 grams of jER YL 983U
Toughener: 10 grams of CLEARSTRENGTH XT 100
Filler: 10 grams of titanium dioxide, Ti-Pure R-960
Filler: 2 grams of AEROSIL A200

In the Part B composition, the following components in the noted amounts were mixed together to form the hardener: Reaction product of 55.5 grams of ANCAMINE 1922A and 44.5 grams of jER YX 8000D; and 20 grams VESTAMIN

PACM.

When the Part A composition and the Part B composition were mixed together and dispensed onto one or more of the noted substrates to be mated, the following data was observed and recorded:
Adhesion Strength:
   Aluminum: 31 MPa
   Titanium: 31.78 MPa
Color Stability: DE94 after 300 hours=2.04
Post chemical bath adhesion:
   Aluminum before chemical bath: 31 MPa
   Aluminum after chemical bath: 26.2 MPa
Young's Modulus: 2.4 GPa
Elongation: 4.34%
Izod: 94 J/m

### Formulation 3

In the Part A composition, the following components in the noted amounts were mixed together:
Resin: 39 grams of jER YX 8000D
Resin: 39 grams of jER YL 983U
Toughener: 10 grams of CLEARSTRENGTH XT 100
Filler: 10 grams of titanium dioxide, Ti-Pure R-960
Filler: 2 grams of AEROSIL A200

In the Part B composition, the following components in the noted amounts were mixed together to form the hardener: Reaction product of 55.5 grams of ANCAMINE 1922A and 44.5 grams of jER YX 8000D

When the Part A composition and the Part B composition were mixed together and dispensed onto one or more of the noted substrates to be mated, the following data was observed and recorded:
Adhesion Strength:
   Aluminum: 20.5 MPa
   Titanium: 20.6 MPa
Color Stability: DE94 after 300 hours=2.52
Post chemical bath adhesion:
   Aluminum before chemical bath: 20.5 MPa
   Aluminum after chemical bath: 17.5 MPa
Young's Modulus: 2.4 GPa
Elongation: 3.35%
Izod: 145 J/m

### Formulation 4

As a comparative formulation, in the Part A composition, the following components in the noted amounts were mixed together:
Resin: 74.5 grams of jER YX 8000D
Toughener: 10 grams of CLEARSTRENGTH XT 100
Filler: 10 grams of titanium dioxide, Ti-Pure R-960
Filler: 2 grams of AEROSIL A200

In the Part B, the following components in the noted amounts were mixed together to form the hardener: 20 grams of ANCAMINE 1618, 42 grams of Priamine 1075 (from Croda), 15 grams of ANCAMINE 1922A.

When the Part A composition and the Part B composition were mixed together and dispensed onto one or more of the noted substrates to be mated, the following data was observed and recorded:
Adhesion Strength:
   Aluminum: 12.15 MPa
   Titanium: 11.09 MPa
   Steel: 14.51 MPa
Color Stability: DE94 after 300 hours=0.36
Young's Modulus: 1.6 GPa
Elongation: 8.7%

What is claimed is:

1. A composition of matter for accelerating reaction of thermosetting monomers, oligomers and/or resins comprising reaction product of (i) one or more hydrogenated bisphenol A or F epoxy resins, or cycloaliphatic epoxy resins, and (ii) diamine- functionalized straight chain alkylene oxides.

2. The composition of matter of claim 1, wherein the one or more hydrogenated bisphenol A or F epoxy resins, or cycloaliphatic epoxy resins, have a number average molecular weight of between about 200 and about 700.

3. The composition of matter of claim 1, wherein the one or more hydrogenated bisphenol A or F epoxy resins, or cycloaliphatic epoxy resins, are present in an amount of about 10 to about 30 percent by weight of the composition of matter.

4. The composition of matter of claim 1, wherein the one or more hydrogenated bisphenol A or F epoxy resins, or cycloaliphatic epoxy resins, is hydrogenated bisphenol A epoxy resin.

5. The composition of matter of claim 1, wherein the one or more hydrogenated bisphenol A or F epoxy resins, or cycloaliphatic epoxy resins, are present in an amount of greater than 0 and up to about 70 percent by weight of the reaction product.

6. The composition of matter of claim 1, wherein the diamine-functionalized straight chain alkylene oxides have a number average molecular weight in the range of about 150 to about 300.

7. The composition of matter of claim 1, wherein the diamine-functionalized straight chain alkylene oxides are present in an amount of 30 to 99 percent by weight of the reaction product.

8. The composition of matter of claim 1, wherein the diamine-functionalized straight chain alkylene oxides are selected from the group consisting of 4,7,10-trioxatridecane-1,13-diamine, 4,9-dioxadodecane-1,12-diamine, polyetheramine D-230, polyetheramine D-400, polyetheramine T-403, and 3,6-dioxaoctamethylenediamine.

9. The composition of matter of claim 1, wherein the diamine-functionalized straight chain alkylene oxides are polyether diamines.

10. The composition of matter of claim 1, wherein the diamine-functionalized straight chain alkylene oxides are polyether diamines derived from polyethylene oxide or polypropylene oxide.

11. The composition of matter of claim 1, wherein the reaction product is an epoxy-amine adduct.

12. A two-part curable composition comprising:
Part A composition comprising a thermosetting monomer, oligomer and/or resin component; a toughener component; and a filler component; and
Part B composition comprising a composition of matter of claim 1.

13. The composition of claim 12, wherein the thermosetting monomer, oligomer and/or resin component is an epoxy resin.

14. The composition of claim 12, wherein the thermosetting monomer, oligomer and/or resin component is an epoxy resin having a number average molecular weight in the range of about 300 to about 700.

15. The composition of claim 12, wherein the thermosetting monomer, oligomer and/or resin component is a bisphenol A or F epoxy resin.

16. The composition of claim 12, wherein the thermosetting monomer, oligomer and/or resin component is hydrogenated bisphenol A or F epoxy resin.

17. The composition of claim 12, wherein the thermosetting monomer, oligomer and/or resin component is cycloaliphatic epoxy resin.

18. The composition of claim 12, wherein the thermosetting monomer, oligomer and/or resin component is present in amount of about 70 to about 85 percent by weight, based on the total Part A composition.

19. The composition of claim 12, wherein the toughener component is a core shell impact modifier.

20. The composition of claim 12, wherein the toughener component is a core-shell impact modifier comprises a polymeric core and at least two polymeric layers surrounding the core, each layer having a different polymer composition from the other layer and, wherein at least one polymeric layer comprises a polymer that is a gradient polymer, the gradient polymer being a copolymer consisting of at least two different monomers (A) and (B) and having a gradient in repeat units arranged from mostly the monomer (A) to mostly the monomer (B) along the copolymer.

21. The composition of claim 12, wherein the toughener component is a core shell impact modifier that comprises a particle having a particle size between about 170 and about 350 nm and a pH between about 6 and about 7.5 comprising one polymeric rubber core comprising at least partially crosslinked isoprene or butadiene and optionally styrene, and at least two polymeric layers wherein at least one polymeric layer is an outermost thermoplastic shell layer having a Tg greater than about 25° C., each layer having a different polymer composition.

22. The composition of claim 12, wherein the toughener component is a core shell impact modifier that comprises a polymeric rubber core surrounded by a polymeric layer which is a polymeric core layer, the polymeric core layer having a glass transition temperature under 0° C. and a different polymer composition than the polymeric rubber core, wherein said polymeric core layer is present in a gradient zone.

23. The composition of claim 12, wherein the toughener component is a core shell impact modifier that comprises at least one polymeric core layer and at least two polymeric shell layers, the polymeric core layer having a different composition than the polymeric core and the shell layers, wherein each shell layer has a different polymer composition from the other shell layer, and wherein at least one polymeric shell layer is present in a gradient zone.

24. The composition of claim 12, wherein the toughener component is a core shell impact modifier that comprises a polymeric rubber core with a glass transition temperature of less than about −40° C.

25. The composition of claim 12, wherein the toughener component is a core shell impact modifier that comprises a polymeric rubber core with a glass transition temperature of between about −80° C. and about −40° C.

26. The composition of claim 12, wherein the toughener component is a core shell impact modifier that comprises a polymeric rubber core constructed from polybutadiene.

27. The composition of claim 12, wherein the toughener component is a core shell impact modifier that comprises a polymeric rubber core constructed from butadiene and styrene.

28. The composition of claim 12, wherein the toughener component is a core shell impact modifier that comprises a polymeric rubber core constructed from methyl methacrylate, butadiene and styrene.

29. The composition of claim 12, wherein the toughener component is a core shell impact modifier is present in an amount of from about 2 percent by weight to about 20 percent by weight, based on the total Part A composition.

30. The composition of claim 12, wherein the filler component comprises titanium dioxide, silica and combinations thereof.

31. The composition of claim 12, wherein the filler component is present in an amount of about 1 to about 20 percent by weight, based on the total Part A composition.

32. Reaction products of the composition of claim 12.

33. Reaction products of claim 12 having two or more of the following physical properties: adhesion strength of between about 20 MPa to about 50 MPa when disposed and cured onto one or more of aluminum, titanium, or steel, color stability as measured by UV resistance DE between 0 and 10 after 300 hours, izod impact strength of between about 50 J/m and about 150 J/m, chemical resistance to 95° C. acid bath having a pH of about 0.1 to about 2 for period of time of about 1 hour while retaining at least about 70% of initial adhesion, Tg of between about 50° C. and about 150° C., modulus between about 1 GPa and about 3 GPa and elongation between about greater than 0% and about 100%.
